(19) United States
(12) Patent Application Publication
(10) Pub. No.: US 2022/0291792 A1
(43) Pub. Date: Sep. 15, 2022

(54) INTERACTIVE SYSTEM AND METHOD OF DIGITIZING AND STUDYING WRITTEN INFORMATION

(71) Applicant: Veronica Alston, Rolesville, NC (US)

(72) Inventor: Veronica Alston, Rolesville, NC (US)

(21) Appl. No.: 17/689,808

(22) Filed: Mar. 8, 2022

Related U.S. Application Data
(60) Provisional application No. 63/161,001, filed on Mar. 15, 2021.

(51) Int. Cl. G06F 3/0483; G10L 15/22; G10L 15/08

(52) U.S. Cl. CPC G06F 3/0483; G10L 15/22; G10L 15/08; G10L 2015/223; G10L 2015/088

(57) ABSTRACT

The invention is directed to a system and method of providing books and other written materials in audible format. In this way, the user can listen to a book while performing other tasks, such as exercising, commuting, and the like. The system further includes a method of digitizing a particular book and/or allowing access to a previously digitized book. Accordingly, the book can be stored in digital format, allowing the user to access the book remotely at any desired time. The system also includes an AI component that allows the user to listen to a selected portion of the digitized book, instruct the system to highlight a particular area of the book for further review, create and listen to flashcards and other study tools, quiz the user, skip desired sections, pause the book, stop reading the book, and the like. Therefore, a user can listen to a book and add customized edits to the book as desired.

### CROSS-REFERENCE TO RELATED APPLICATIONS

This application claims priority to U.S. Provisional Patent Application No. 63/161,001, filed Mar. 15, 2021, the entire content of which is incorporated by reference herein.

### TECHNICAL FIELD

The presently disclosed subject matter is directed to an interactive system and method of digitizing, reading, studying, and/or editing written information, such as textbooks and the like.

### BACKGROUND

People read for a variety of reasons, including enjoyment, education, conducting research, gathering business-related information, keeping in touch with current affairs, and the like. Every day around the world, a significant amount of time, effort, and mental energy goes into reading. However, even those with good memories will remember only a small proportion of the content that they read. As a result, people often annotate books by writing in the margins, insert bookmarks, use adhesive notes, or transcribe passages onto notecards. However, these solutions have limitations. For example, writing annotations in the margin of a book is only appropriate for the owner of the book. Other items, such as bookmarks and writing paper, are not always available. Taking handwritten notes is also time-consuming and the notes can easily become misplaced.

In the last twenty years, the use of personal computing devices (e.g., laptop computers, tablets, smart phones, smart watches) has grown tremendously. These personal computing devices provide users with a broad range of learning opportunities, interactive applications, communication abilities, and the like. However, technology related to the ways that information is input and retained by a user has not kept up with changing technology. For example, users are able to check their heart rate using their phone, can use artificial intelligence (AI) to turn lights in the home on and off, and can easily remotely start their vehicle. However, users must still sit down, read, and study books the old-fashioned way.

It would therefore be beneficial to provide a system and method of utilizing electronic data while reading, including the ability to copy, edit, search, classify, annotate, and distribute information with ease.

### SUMMARY

In some embodiments, the presently disclosed subject matter is directed to a system for reading and interacting with a digitized version of a book. Specifically, the system comprises an element that enables either digitizing the book or accessing a digitized version of the book. The system also includes a digital storage medium that stores the digitized book. The system further includes an AI component that receives commands from a user to take one or more actions relative to the book. The one or more actions are selected from: providing information about the book, reading the book aloud to the user, reading a selected portion of the book aloud to the user, pausing the reading of the book aloud to the user, resuming the reading of the book to the user, highlighting a selected portion of the book, adding a bookmark to a selected portion of the book, adding a note to a selected portion of the book, create a flashcard, read a flashcard to the user, or combinations thereof.

In some embodiments, the book is selected from a textbook, fiction book, nonfiction book, magazine, pamphlet, newspaper, journal, article, or combinations thereof.

In some embodiments, the element that enables digitizing the book is selected from one or more scanners, cameras, microphones, or keyboards.

In some embodiments, the digitized book is in color.

In some embodiments, the system is configured to map the digitized book according to a layout of the book, including line numbers, paragraph numbers, pages, chapters, or combinations thereof.

In some embodiments, the digital storage medium, AI, or both are accessible through an electronic display on a computer, mobile phone, electronic book reader, smart watch, personal digital assistant, or combinations thereof.

In some embodiments, the system further comprises a digital assistant function that interprets user input in spoken form, textual form, or both to infer user intent and perform actions based on the user intent.

In some embodiments, the digital assistant is activated used a particular name.

In some embodiments, the one or more actions taken by the AI component are the provision of information and the performance of a task.

In some embodiments, the user can at any time add, delete, or edit an action taken by the system.

In some embodiments, the system is configured as a mobile application.

In some embodiments, the presently disclosed subject matter is directed to a method of interacting with a book. Particularly, the method comprises activating the disclosed system for reading and interacting with a digitized version of the book. The method includes selecting a desired book from the digital storage medium. The method includes providing instructions to the AI component to take one or more actions relative to the book selected. The actions comprise one or more of providing information about the book, reading the book aloud, reading a selected portion of the book aloud, highlighting a section of the book, adding a bookmark, removing a bookmark, adding a note, removing a note, pause reading of the book, stop reading of the book, creating a flashcard, and reading a flashcard.

In some embodiments, selecting of a desired book is accomplished through a user voice command.

### BRIEF DESCRIPTION OF THE DRAWINGS

The previous summary and the following detailed descriptions are to be read in view of the drawings, which illustrate some (but not all) embodiments of the presently disclosed subject matter.

FIG. 1 is a schematic illustrating a system of digitizing and studying written materials in accordance with some embodiments of the presently disclosed subject matter.

FIG. 2 is a schematic that illustrates methods of digitizing books to a central data storage medium in accordance with some embodiments of the presently disclosed subject matter.

FIG. 3 is a flow chart illustrating a method of using the disclosed system in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−0.1-20% from the specified amount, as such variations are appropriate in the disclosed packages and methods.

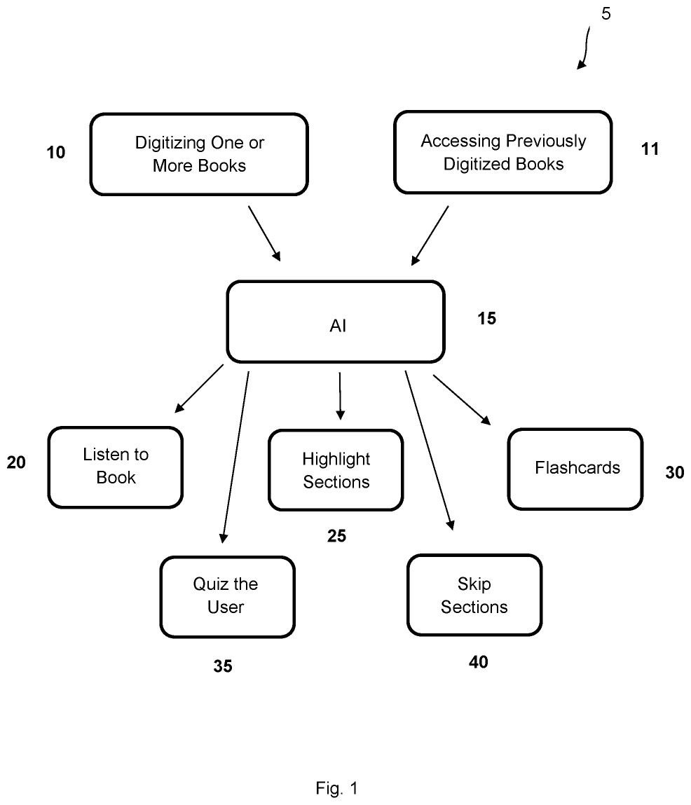

The presently disclosed subject matter is directed to a system and method of providing books and other written materials in audible format. In this way, the user can listen to a book while performing other tasks, such as exercising, commuting, and the like. As shown in FIG. 1, the disclosed system 5 includes a method of digitizing a particular book and/or allowing access to a previously digitized book, as set forth in steps 10, 11. The system also includes AI component 15 that allows the user listen to a selected portion of a digitized book at step 20, instruct that an area of the book be highlighted for further review at step 25, create and listen to flashcards and other study tools at step 30, quiz the user at step 35, skip desired sections at step 40, and the like as described in detail below.

As set forth above, the disclosed system includes a method of digitizing a book and/or a method of accessing a previously digitized book. The term “book” as used herein refers to broadly to any written material that can be read aloud by system 5. Thus, “books” can include textbooks, fiction books, nonfiction books, magazines, pamphlets, newspapers, journals, periodicals, articles, and the like. The term “digitizing” refers to the conversion of material from a written hard copy (e.g., paper) format to a digital format, such as the conversion of a written book to a digital version of the book that can be viewed on an electronic device (e.g., tablet, computer, phone) or stored as an audio file.

For the purposes of the presently disclosed subject matter, the term “user” refers to any individual, group of individuals, organization, etc. that uses, views, etc. the system as described herein.

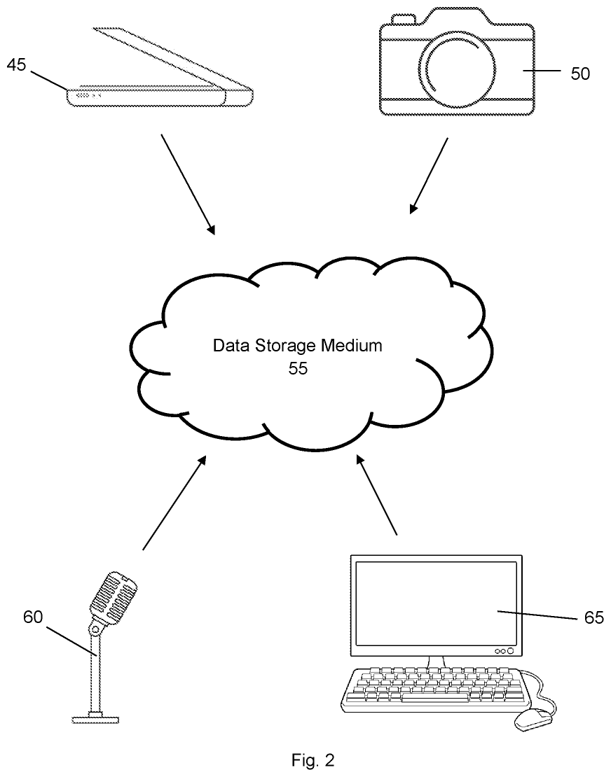

Any method of digitizing a book to store and/or capture information from the book can be used. As shown in FIG. 2, optical capture using scanner 45 or camera 50 can be employed. In these methods, the images from the book are copied page-by-page until the entire book has been input. The book can then be uploaded to central data storage medium 55 for access by one or more users. In other embodiments, the book contents may be captured by reading aloud from the book into an audio capture device 60 and/or typing it on a keypad or keyboard 65. However, it should be appreciated that any known method of capturing the content of a book and converting it into digital format can be used.

The book can be uploaded in black and white or can include color images. For example, graphs, photographs, and the like often include color portions that can be included and stored in data storage medium 55.

After the digital image of the book is created, it can be converted into an image data file and/or audio file and stored in data storage medium 55. The term “data storage medium” includes any form of media upon which data can be stored. In some embodiments, the data storage medium can be digital format, as well as flash drives and the like. In some embodiments, the digital image of the book reflects an audible reading of the book stored in one or more audio files. The one or more audio files can be selected from AAC, MP3, WAV, and/or PCM.

Optionally, the data file can be polished using conventional methods. For example, data can be enhanced by cropping, adjusting brightness, adjusting color, sound clarity, background noise, and the like.

In some embodiments, the disclosed system can also allow access to previously scanned books. There are several conventional databases that include digitized books, such as Google®, Audible®, Kindle®, and the like.

After the book has been digitized and/or accessed, it can then be mapped by the disclosed system. The term “mapping” refers to the organization of the book according to the book's layout (e.g., sequential pages, paragraphs, chapters, etc.). Thus, the book can be mapped to indicate a chapter number, a paragraph number, and/or a line number. In this way, the book can be divided into several segments or sections, as well as allow the system to identify where each section begins and ends. In some embodiments, the book can be mapped during digitization, such as while the book is being scanned and/or uploaded. In other embodiments, the book can be mapped after digitization.

As set forth above, the disclosed system 5 can include providing or accessing a digital copy of the book to be read. Once system 5 has associated each page in a book with a particular digital entity, the system can build a huge amount of functionality in the association.

The contents of the data storage medium are available and accessible through an electronic display or monitor, such as on a personal computer, mobile phone, electronic book reader, personal digital assistant (PDA), and the like. The electronic device provides an audio output via one or more speakers. The electronic device is also capable of receiving speech input from the user (e.g., via a microphone of the electronic device). The electronic device can therefore derive user intent based on the speech input. The system can then identify a task based on the derived user intent and perform the identified task.

In some embodiments, the AI (artificial intelligence) portion of system 5 can include an automated assistant. The digital assistant can be any information processing system that interprets user input in spoken and/or textual form to infer user intent and perform actions based on the user intent. For example, to act on user intent, the system can identify a task flow with steps and parameters designed to accomplish the user intent, input specific requirements into the task flow, execute the task flow by invoking programs, methods, services, or the like, and generate output responses to the user in an audible (e.g., speech) and/or visual form. The digital assistant can be activated using a particular name (e.g., Veronica).

In some embodiments, the digital assistant can be capable of accepting a user request at least partially in the form of a natural language command, request, statement, narrative, and/or inquiry. Thus, the user request can seek an informational answer, and the digital assistant can provide the requested answer. For example, a user can ask the digital assistant a question relative to a particular book, such as “how many pages are left in this chapter?” Based on the current book data present in data storage medium 55, the digital assistant can answer, “There are 3 pages left in this chapter.” It should be appreciated that a wide variety of information can be asked, and answers provided by system 5 (e.g., the number of pages in a chapter, the number of lines in a paragraph, author/publisher information, subsequent book volumes, and the like).

In addition, the digital assistant can perform one or more tasks at the user's request. For example, the user can ask the system to take action with respect to the book (e.g., “skip ahead to Chapter 4”). In response, the digital assistant can optionally acknowledge the request by saying “Yes, right away” or another similar confirmation. The digital assistant can then take the requested action (e.g., begin reading Chapter 4 aloud as requested by the user). During performance of a requested task, the digital assistant can interact with the user in a continuous dialogue involving multiple exchanges of information over an extended period of time.

It should be appreciated that the disclosed system can perform a wide variety of tasks at the user's request. For example, the system can read aloud a selected book from start to finish. Alternatively, the user can interact with the system to direct the reading of a particular section of the book. For example, a particular selection of one or more sentences, paragraphs, and/or chapters can be selected by the user (e.g., “read chapter one” or “read the third paragraph on page 15”). The system will then begin reading the selected section until the task is completed. At any time, the user can direct the system to pause or stop reading by issuing a voice command. The user can direct the system to resume reading again at any desired time.

The reading can be controlled by the user using further input. For example, the language of speech can be selected (e.g., English, Spanish, etc.). In addition, the speed of reading by the system can be adjusted based on user preferences. Similarly, the volume can be selected based on the user's environment and/or preferences.

In some embodiments, the system can directly interact with the user based on the mapping of the book. For example, at the end of a chapter, the system can ask questions to test and/or challenge the user. The questions or test can be generated by the book or by the system. The system is also capable of answering questions aloud upon direction by the user.

In some embodiments, the system can create flashcards and other similar learning tools at the user's request. The learning tools are digitally stored and created so that the user can review them later (e.g., during studying). The user can read the flashcards and/or can ask the system to read the flash cards aloud to the user. The flashcards can be edited or deleted using similar voice commands.

In some embodiments, the system can highlight a selected passage of a book through instruction by the user. As used herein, the term “highlighted” refers to an area of a book that is visually distinguished from another area that is concurrently displayed. Highlighting can involve changing the font of text, changing the font style of text (e.g., italicize, bold, underline), changing the size of text, changing the color of text, changing the background color of text, or combinations thereof. In some implementations, the user can filter the displayed highlighted portions of text based on the color used to highlight the text, the particular chapter of the highlighted text, the date that the text was highlighted, etc. For example, the user can indicate that he or she only wants to see or hear text that was highlighted in red, and system will then only display or read the red highlighted text.

Thus, as a book is being read by the system, a user can instruct the AI to highlight selected text. The highlighted portion(s) are then saved by the system, allowing the user to later review, sort, and/or delete the highlighting as desired. In some embodiments, the highlighted text will remain visible on the digital version of the book. The color of the highlight can be customized by the user (e.g., green). In some embodiments, the user can highlight different portions of text with different colors, such as to categorize the highlighted text. The highlighting in a particular section can be easily removed by the user by providing instruction to the AI.

The system can further allow a user to make a note, such as to provide a comment or clarification. The note can be added by providing the audible command “add a note,” “add a note to refer back to this sentence”, etc. The AI will then respond by adding a note to that section in accordance with the user direction. The note can be displayed in any desired location of the book, such as in the margins, overlaying text, a separate sheet, or can be stored as an audio file to be reviewed later by the user.

Similarly, the user can direct the system to add a bookmark to a desired page or section of the book. For example, the user can ask the AI to “add a bookmark here” or “Veronica, add a bookmark to Chapter 2.” The system will respond by adding a bookmark to the desired location, allowing the user to easily refer back to the location as needed.

The location of each note and/or bookmark can be rearranged according to user preference. For example, a note or bookmark can be moved to a different page or chapter by instructing the AI to move to the new location. In addition, any notes and bookmarks can be easily removed by the system upon request by the user (“remove the bookmark on page 214”). The notes and bookmarks can further be read aloud by the system to the user when desired.

The system is further capable of creating and/or reading an overview of a particular book, an overview of a particular chapter or section, and the like. The system overview can be provided in the content of the book text. Alternatively, the overview can be provided by the user and uploaded to the data storage medium.

In some embodiments, the disclosed system can be configured as a mobile application or downloadable application on electronic device having any a screen. The screen can also display icons, images, graphics, hyperlinks, and any other of common computer and/or internet-related objects. The device can be a desktop computer, a laptop computer, a tablet computer, a smart phone, a smart watch, and/or a dedicated e-book reader.

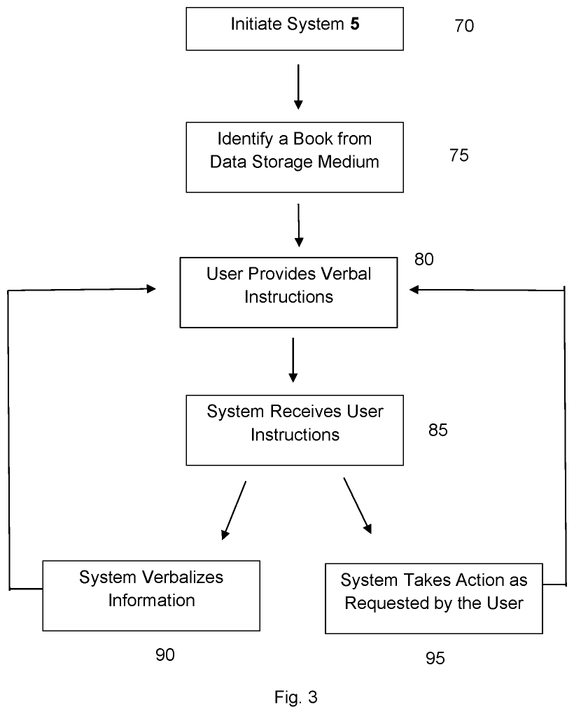

In use, the system can be initiated by opening a corresponding mobile application, logging into a website, voice activation, and the like, as illustrated in step 70 of FIG. 3. For example, a user can say the word “Activate” to activate the system. Alternatively, the user activates the system by using the digital assistant feature (“Veronica”). The user can then identify a particular book to be read by title, author, subject matter, or some other identifier (e.g., “Veronica, open my Chemistry book”) at step 75. The system receives the user's command and accesses the desired book. The user can then interact with system 5 by providing one or more voice commands that are received by the system and processed to produce a desired action at steps 80, 85. Representative commands can include informational requests, such as information about the book (author, date published, publisher information, number of pages in the book, description of tables or graphs, etc.), information about the reading of the book (e.g., the number of pages left in a book, description of a table, the number of minutes left in a chapter, etc.), and the like. User commands can also include requests for action, such as (but not limited to) an instruction to begin reading the book, begin reading the book at a desired location (a desired line, sentence, paragraph, chapter, etc.), pause reading, stop reading, add a bookmark, remove a bookmark, create a flashcard, remove a flashcard, create a note, remove a note, highlight a section, remove highlighting, ask chapter quiz questions, answer book quiz questions, and the like. After the system provides the requested information or takes the requested action as illustrated in steps 90, 95, the user can provide additional verbal instructions as desired. When the user has finished using the system, he or she simply closes the system until it is needed again.

The disclosed system offers many advantages over prior art systems. Particularly, the system enables a user to access a book easily and quickly without having to physically carry the book.

The system is eco-friendly, saving money on paper by providing digital access to one or more books.

The disclosed system allows a user to quickly add highlighting, bookmarks, notes, and the like to a selected section of a book.

Advantageously, the disclosed system is easy to use, such that even children and the elderly can take advantage of the system.

The disclosed system is portable and can be used in any desired location, such as while commuting, while exercising, at work, and the like. System 5 therefore saves the user time by allowing him or her to multitask.

Students can have the option of buying a hard copy version of a textbook or the audio version with built in AI. Students can then listen to their textbooks on the go through the application on their mobile devices.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

### EXAMPLES

The following Examples provide illustrative embodiments. In light of the present disclosure and the general level of skill in the art, those of ordinary skill in the art will appreciate that the following Examples are intended to be exemplary only and that numerous changes, modifications, and alterations can be employed without departing from the scope of the presently disclosed subject matter.

### Prophetic Example 1

### Initiating the Disclosed System

A user can access a desired book (e.g., a textbook) by initiating the system by saying “Veronica.” The system AI then awakens and is ready for use by the user. Alternatively, the user can open their mobile device or computer and activate the system by opening a mobile application or logging in. The system is then ready for instruction by the user.

### Prophetic Example 2

### Suitable Voice Commands from User to the System

Once the system is activated as set out in Example 1, the user can interact with the system through a variety of representative voice commands as set out below in Table 1. It should be appreciated that the term “Veronica” is representative of any name that can be used. Further, the name can be omitted in some embodiments such that user only provides the voice command.

TABLE 1
User Voice Commands and Resultant System Reactions

| User Voice Command | System Reaction |
|---|---|
| Veronica | AI awakens |
| Veronica, read Chapter 1 in | AI begins reading Chapter 1 in |
| Community Psychology | Community Psychology |
| Veronica, pause | AI pauses, reading stops |
| Veronica, place bookmark | AI remembers where the reading |
| here | last stopped, placing a bookmark |
| Veronica, resume | AI continues reading from a |
| Community Psychology | bookmark |
| Veronica, repeat that | AI repeats the last sentence, |
| sentence/paragraph/chapter | paragraph, or chapter read |
| Veronica, highlight that | AI highlights the last sentence, |
| sentence/paragraph/chapter | paragraph, or chapter read |
| Veronica, read highlights | AI reads highlighted areas |
| from Chapter 1 in | previously marked by the user |
| Community Psychology | |
| Veronica, read a summary | AI reads a summary of Chapter 1 |
| of Chapter 1 | |
| Veronica, read FIG. 1.1 | AI reads and/or describes the |
| | selected Figure |
| Veronica, describe Table 1.1 | AI reads and/or describes the |
| | selected Table |
| Veronica, quiz me on | AI quizzes the user according to the |
| Chapter 1 | flashcards created by the user |
| Veronica, go to the author | AI reads the author index starting |
| index and read the names | with the letter “A” |
| that begin with an “A” | |
| Veronica, skip to the next | AI skips to the next chapter, |
| chapter/paragraph/sentence | paragraph, or sentence |
| Veronica, skip the reference | AI skips the reference section |
| section | |
| Veronica, read the references | AI reads the references in |
| in Chapter 1 | Chapter 1 |

### Prophetic Example 3

### Representative Questions from the System to the User

Once the system is activated, the user can interact with the user through a variety of questions, as set out below in Table 2:

TABLE 2
System Questions and Resultant System Reactions

| System Question | System Reaction |
|---|---|
| Do you want me to read by | AI reads according to user instructions |
| columns or rows? | |
| Would you like to see an | A visual representation of FIG. 1 is |
| image of FIG. 1? | shown to the user or no image is shown, |
| | depending on user instructions |
| Would you like to take a quiz | A quiz is either given to the user or not |
| on Chapter 1? | given to the user, depending on user |
| | instructions |
| Shall I continue reading the | AI begins reading the next chapter or |
| next chapter? | stops reading, depending on user input |

What is claimed is:

1. A system for reading and interacting with a digitized version of a book, the system comprising:
an element that enables either digitizing the book or accessing a digitized version of the book;
a digital storage medium that stores the digitized book;
an AI component that receives commands from a user to take one or more actions relative to the book;
wherein the one or more actions are selected from:
providing information about the book;
reading the book aloud to the user;
reading a selected portion of the book aloud to the user;
pausing the reading of the book aloud to the user;
resuming the reading of the book to the user;
highlighting a selected portion of the book;
adding a bookmark to a selected portion of the book;
adding a note to a selected portion of the book;
create a flashcard;
read a flashcard to the user; or
combinations thereof.

2. The system of claim 1, wherein the book is selected from a textbook, fiction book, nonfiction book, magazine, pamphlet, newspaper, journal, article, or combinations thereof.

3. The system of claim 1, wherein the element that enables digitizing the book is selected from one or more scanners, cameras, microphones, or keyboards.

4. The system of claim 1, wherein the digitized book is in color.

5. The system of claim 1, wherein the system is configured to map the digitized book according to a layout of the book, including line numbers, paragraph numbers, pages, chapters, or combinations thereof.

6. The system of claim 1, wherein the digital storage medium, AI, or both are accessible through an electronic display on a computer, mobile phone, electronic book reader, smart watch, personal digital assistant, or combinations thereof.

7. The system of claim 1, further comprising a digital assistant function that interprets user input in spoken form, textual form, or both to infer user intent and perform actions based on the user intent.

8. The system of claim 7, wherein the digital assistant is activated used a particular name.

9. The system of claim 1, wherein the one or more actions taken by the AI component are the provision of information and the performance of a task.

10. The system of claim 1, wherein the user can at any time add, delete, or edit an action taken by the system.

11. The system of claim 1, configured as a mobile application.

12. A method of interacting with a book, the method comprising:
activating a system for reading and interacting with a digitized version of the book, the system comprising:
an element that enables either digitizing the book or accessing a digitized version of the book;
a digital storage medium that stores the digitized book;
an AI component that receives commands from a user to take one or more actions relative to the book;
wherein the one or more actions are selected from:
providing information about the book;
reading the book aloud to the user;
reading a selected portion of the book aloud to the user;
pausing the reading of the book aloud to the user;
resuming the reading of the book to the user;
highlighting a selected portion of the book;
adding a bookmark to a selected portion of the book;
adding a note to a selected portion of the book;
create a flashcard;
read a flashcard to the user; or
combinations thereof;
selecting a desired book from the digital storage medium;
providing instructions to the AI component to take one or more actions relative to the book selected;
wherein the actions comprise one or more of providing information about the book, reading the book aloud, reading a selected portion of the book aloud, highlighting a section of the book, adding a bookmark, removing a bookmark, adding a note, removing a note, pause reading of the book, stop reading of the book, creating a flashcard, and reading a flashcard.

13. The method of claim 12, wherein the selecting of a desired book is accomplished through a user voice command.

14. The method of claim 12, wherein the book is selected from a textbook, fiction book, nonfiction book, magazine, pamphlet, newspaper, journal, article, or combinations thereof.

15. The method of claim 12, wherein the digital storage medium, AI, or both are accessible through an electronic display on a computer, mobile phone, electronic book reader, smart watch, personal digital assistant, or combinations thereof.

16. The method of claim 12, further comprising a digital assistant function that interprets user input in spoken form, textual form, or both to infer user intent and perform actions based on the user intent.

17. The method of claim 16, wherein the digital assistant is activated used a particular name.

18. The method of claim 12, wherein the one or more actions taken by the AI component are the provision of information and the performance of a task.

19. The method of claim 12, wherein the user can at any time add, delete, or edit an action taken by the system.

20. The method of claim 12, configured as a mobile application.
